(19) United States
(12) Patent Application Publication
(10) Pub. No.: US 2012/0270564 A1
(43) Pub. Date: Oct. 25, 2012

(54) METHODS AND APPARATUSES FOR USE IN A MOBILE DEVICE TO DETECT SIGNALING APERTURES WITHIN AN ENVIRONMENT

(75) Inventors: Arnold Jason Gum, San Diego, CA (US); Lionel J. Garin, Sunnyvale, CA (US)

(73) Assignee: QUALCOMM INCORPORATED, San Diego, CA (US)

(21) Appl. No.: 13/219,507

(22) Filed: Aug. 26, 2011

Related U.S. Application Data
(60) Provisional application No. 61/477,087, filed on Apr. 19, 2011.

(51) Int. Cl. H04W 24/00; H04W 4/02

(52) U.S. Cl. 455/456.3; 455/456.1

(57) ABSTRACT

Methods, apparatuses and articles of manufacture are provided that may be implemented in a mobile device to determine whether one or more signaling apertures may be present within an environment based, at least in part, on a presence or an absence of a reflected version of a detection signal in a received signal, and affect an operation of at least one function based, at least in part, on a determination as to whether a signaling aperture is determined to be present or absent within the environment.

This patent application claims benefit of and priority to co-pending U.S. Provisional Patent Application 61/477,087, filed Apr. 19, 2011, Titled, “METHODS AND APPARATUSES FOR AFFECTING A NAVIGATION FUNCTION IN A MOBILE DEVICE”, and which is hereby incorporated by reference.

### BACKGROUND

1. Field

The subject matter disclosed herein relates to electronic devices, and more particularly to methods, apparatuses and articles of manufacture for use in a mobile device.

2. Information

The Global Positioning System (GPS) represents one type of Global Navigation Satellite System (GNSS), which along with other types of satellite positioning systems (SPS) provide or otherwise support signal-based position location capabilities (e.g., navigation functions) in mobile devices, and particularly in outdoor environments. However, since some satellite signals may not be reliably received and/or acquired by a mobile device within an indoor environment or other like mixed indoor/outdoor environments, different techniques may be employed to enable position location services.

For example, mobile devices may attempt to obtain a position fix by measuring ranges to three or more terrestrial transmitting devices (e.g., wireless access points, beacons, cell towers, etc.) which are positioned at known locations. Such ranges may be measured, for example, by identifying transmitting devices (e.g., by obtaining a MAC ID address or the like from signals received from such transmitting devices) and obtaining range measurements to the transmitting devices by measuring one or more characteristics of signals received from such transmitting devices such as, for example, signal strength, a round trip delay time, phase offset, etc.

As pointed out above, a navigation function may measure ranges to transmitting devices at known locations by processing signals received from such transmitting devices. It is also typically the case that a mobile device may have several transmitting devices to chose from, each transmitting device at a different location. Here, such received signals are preferably received from selected transmitting devices via an unobstructed, line-of-sight (LOS) direction. The presence of an obstruction that interferes with such LOS reception at a mobile device may lead to less desirable multi-path reception, or a much weaker signal; or possibly block the signal altogether. In such a case, a mobile device may be slower at determining a position fix (e.g., weaker signals may lead to longer integration times, etc.), and may consume substantial battery life attempting to acquire such a signal (and may not be able to acquire such a signal). It should also be understood that mobile devices with navigation functions typically have limited battery life, which may be consumed by performing scans and/or searches in attempt to acquire navigation signals.

As such, it may be beneficial to reduce delays in signal reception/processing and/or to conserve battery life, when providing a navigation function in a mobile device.

### SUMMARY

In accordance with certain aspects, various methods, apparatuses and articles of manufacture are provided that may be implemented in or at a mobile device to determine whether a signaling aperture is present within an environment based, at least in part, on a presence or an absence of a reflected version of a transmitted detection signal in a received signal, and affect an operation of at least one function based, at least in part, on a determination as to whether a signaling aperture is determined to be present or absent within the environment.

In certain example implementations, a method may comprise at a mobile device: determining whether a signaling aperture is present within an environment based, at least in part, on a presence or an absence of a reflected version of a detection signal in a received signal; and affecting an operation of at least one function based, at least in part, on the determination as to whether the signaling aperture is present within the environment.

In certain other example implementations, an apparatus for use in a mobile device may comprise: means for transmitting a detection signal; means for receiving a received signal; means for determining whether a signaling aperture is present within an environment based, at least in part, on a presence or an absence of a reflected version of the detection signal in the received signal; and means for affecting an operation of at least one function based, at least in part, on the determination as to whether the signaling aperture is present within the environment.

In still other example implementations, a mobile device may comprise: a transmitter; a receiver; and a processing unit to: initiate transmission of a detection signal within an environment via the transmitter; obtain a signal received via the receiver; determine whether a signaling aperture is present within the environment based, at least in part, on a presence or an absence of a reflected version of the detection signal in the received signal; and affect an operation of at least one function based, at least in part, on the determination as to whether the signaling aperture is present within the environment.

In yet other example implementations, an article of manufacture may be provided which comprises a non-transitory computer readable medium having stored therein computer-implementable instructions executable by one or more processing units of a mobile device to: initiate transmission of a detection signal within an environment; obtain a signal received within the environment; determine whether a signaling aperture is present within the environment based, at least in part, on a presence or an absence of a reflected version of the detection signal in the received signal; and affect an operation of a at least one function based, at least in part, on the determination as to whether the signaling aperture is present within the environment.

### BRIEF DESCRIPTION OF DRAWINGS

Non-limiting and non-exhaustive aspects are described with reference to the following figures, wherein like reference numerals refer to like parts throughout the various figures unless otherwise specified.

FIG. 1 is a schematic block diagram illustrating an example environment that includes a mobile device enabled to affect a navigation function based, at least in part, on a determination of whether a signaling aperture is present, in accordance with an implementation.

FIG. 2 is a schematic block diagram illustrating certain features of an example mobile device enabled to affect a navigation function based, at least in part, on a determination of whether a signaling aperture is present in an environment, in accordance with an implementation.

FIG. 3 is a functional flow diagram illustrating certain features of an example method for use in a mobile device to affect a navigation function based, at least in part, on a determination of whether a signaling aperture is present in an environment, in accordance with an implementation.

FIGS. 4-7 are schematic block diagrams illustrating certain example environments that include a mobile device enabled to affect a navigation function based, at least in part, on a determination of whether a signaling aperture is present, in accordance with certain implementations.

### DETAILED DESCRIPTION

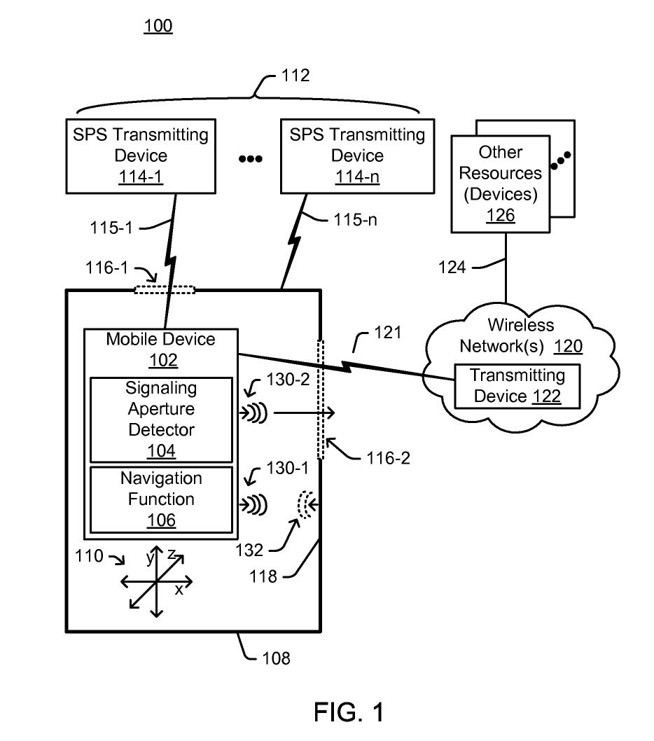

FIG. 1 is a schematic diagram illustrating certain features of an example environment 100 comprising a mobile device 102 which is shown as being within a structure 108. As shown, mobile device 102 may, for example, comprise a signaling aperture detector 104 and a navigation function 106. Mobile device 102 may, for example, receive one or more satellite positioning signals (SPS) signals 115 transmitted by one or more SPS transmitting devices 114 of an SPS 112. For example, as shown in FIG. 1, SPS transmitting device 114-1 may transmit SPS signal 115-1 and SPS transmitting device 114-n may transmit SPS signal 115-n, (e.g., where n is an integer greater than one).

In a particular example, as illustrated in FIG. 1 and described in greater detail below, mobile device 102 may be able to adequately receive SPS signal 115-1 due to the presence of a “signaling aperture” 116-1 within environment 100 which permits SPS signal 115-1 to reach mobile device as needed for reception. Here, for example, SPS signal 115-1 may travel a line-of-site (LOS) path and/or multiple paths (e.g., non-line-of-sight (NLOS)) from SPS transmitting device 114-1 to mobile device 102. Signaling aperture 116-1 may, for example, comprise an opening in structure 108, or perhaps one or more materials through which certain electromagnetic signals (e.g., a radio frequency (RF) signals (e.g., in the range of about 30 kHz to 300 GHz), etc.), may pass through without being completely absorbed, reflected, or otherwise substantially attenuated. By way of example, signaling aperture 116-1 may be associated with a glass window, a door or doorway, a wall, a ceiling, a floor, a roof, etc., associated with structure 108 and/or object(s) (not shown) within environment 100. All or part of structure 108 may, for example, be representative of one or more natural and/or man-made objects or materials. All or part of structure 108 may, for example, represent part of an indoor environment or a mixed indoor/outdoor environment.

Conversely, as further illustrated in this example, mobile device 102 may be unable to adequately receive SPS signal 115-n due to the absence of a “signaling aperture” within environment 100 which might permit SPS signal 115-n to reach mobile device as needed for reception. Here, for example, various materials in structure 108 and/or object(s) (not shown) within environment 100 may completely absorb, reflect or otherwise substantially attenuate certain electromagnetic signals (e.g., a radio frequency (RF) signals, etc.).

Similarly, as illustrated in FIG. 1, mobile device 102 may be able to adequately receive and/or transmit a wireless network signal 121 from and/or to a transmitting device 122 of a wireless network 120 via a signaling aperture 116-2, should transmitting device 122 be located external to structure 108. It should be noted that a presence or absence of a “signaling aperture” may vary depending upon the environment and transmission/reception capabilities of the transmitting and/or receiving devices. For example, certain signals may be capable of passing through certain materials better than other signals. For example, certain transmitting devices may transmit signals with greater signal strengths, and/or may be closer to a receiving device (e.g., mobile device) than other transmitting devices. For example, a mobile device may be capable of receiving certain signals better than other signals, e.g., via different antenna(s), receivers, etc. Furthermore, in certain instances, a presence of a signaling aperture may affect a shape and/or a timing of a reflection off certain boundaries associated with the signaling aperture versus the aperture itself (e.g., as in a waveguide, or the like).

In the example illustrated in FIG. 1, navigation function 106 may be arranged to use one or more SPS signals transmitted by an SPS transmitting device 114, and/or one or more wireless network signals (or the like) transmitted by transmitting device 122, to estimate a range, a pseudorange, a position, a geographical location, a velocity, an elevation, and/or the like associated with mobile device 102. In certain example instances, mobile device 102 may attempt orientation via one or more sensors (e.g., magnetometer(s), accelerometer(s), gyrometer(s), and/or the like or combination thereof).

In accordance with certain aspects of the present description, it may be beneficial for mobile device 102 to be able to detect one or more signaling apertures via which one or more electromagnetic signals may be received and/or transmitted. It is noted that, in certain instances, mobile device 102 may receive signals at varying strengths through one or more signaling apertures and that by noting which strong signals are present and which are stronger/weaker may estimate relative directions towards such signaling apertures. In certain instances, it may be beneficial to know or estimate time and/or ephemeris for an SPS as well since such may be used determine a location of the constellation. Hence, with knowledge of a direction of one or more signaling apertures, in an absolute sense relative to a structure (building), mobile device 102 may determine a relative direction of such a signaling aperture(s) to the mobile and a relative location of mobile device 102 to the signaling aperture(s). In certain example implementations, such a capability may allow for estimating a rough direction which may allow for calibration of a compass, etc. As described in the example implementations herein, signaling aperture detector 104 may provide such a capability by initiating transmission of a detection signal 130 and determining whether a signaling aperture 116 is present within environment 100 based, at least in part, on a presence or an absence of a reflected version 132 of detection signal 130 in a corresponding received signal. It should also be understood that in certain instances, there may be some reflection but the intensity of that reflection and the multipath associated with it (multiple peaks) may vary depending on whether a mobile device may be oriented at an aperture/discontinuity in the surroundings or not. Ratios of signal strength related peaks may also vary depending on a size or type of signaling aperture and/or some other characteristic of the transmitted signal. In certain example implementations, it may be useful to modify an orientation of a signal to minimize the side lobes to ascertain a closest direction of a signaling aperture. In certain example implementations, mobile device 102 may also modify a spread of a beam to determine a size and/or a direction of an aperture from narrow to broader and extending in a particular direction to detect boundaries of a signaling aperture.

For example, as illustrated in FIG. 1, mobile device 102 may transmit a detection signal 130-1 and a reflecting object 118 may cause reflected version 132 to be identifiable within a subsequently received signal. In this example, reflecting object 118 is illustrated as being part of structure 108. Thus, in this example, signaling aperture detector 104 may determine that a signaling aperture 116 is not present within environment 100 based, at least in part, on a presence reflected version 132 of detection signal 130-1 in the received signal. In certain example implementations, mobile device 102 may obtain and use a map of signaling apertures to estimate its location or position with regard to a structure, building, room, etc., based on a presence or an absence of signaling apertures. For example, mobile device 102 may detect signaling apertures present based on reflections and may also consider strengths of incoming signals from known transmitting devices to determine an orientation.

However, as further illustrated in FIG. 1, mobile device 102 may, for example, transmit a detection signal 130-2 which may not result in a substantial reflected version in the received signal. For example, detection signal 130-2 may substantially pass through or otherwise be affected in some manner by a signaling aperture 116-2 such that a reflected version may not be identified within a subsequently received signal. Thus, in this example, signaling aperture detector 104 may determine that a signaling aperture 116 is present within environment 100 based, at least in part, on an absence of a reflected version of detection signal 130-2 in the received signal. In certain example instances, a returned wave form may vary based upon a distance, a size, a shape, and/or composition of a signaling aperture, and based, at least in part, thereon mobile device 102 may characterize a signaling aperture as being of a particular type (e.g., a window, a door, a thin wall, etc.). In certain example implementations, mobile device 102 may also consider data gathered using one or more sensors, e.g., such as light sensors to determine a type of aperture based on spectrum composition (fluorescent versus natural light, filtering characteristics of different types of glass, etc.). In certain example implementations, mobile device 102 may combine a shape of a reflection with its timing from various portions of a signaling aperture, to estimate a size of the signaling aperture.

In certain example implementations, a signaling aperture decision may, for example, be based, at least in part, on whether a signal strength of reflected version satisfies a particular signal strength threshold, or measuring/comparing multiple thresholds to figure out boundary versus signaling aperture, signaling aperture composition, etc. In certain example implementations, a signaling aperture decision may, for example, be based, at least in part, on whether a measured time (or corresponding estimated range) between transmission of detection signal and reception of a reflected version satisfies a particular time (or range) threshold. In certain example implementations, a signaling aperture decision may be based, at least in part, on one or more signal characteristics of one or more returned signals, e.g., comparing strengths of peaks and/or proportions relative to one another, etc.

In certain example implementations, a detection signal may be transmitted in a particular direction with respect to mobile device 102, and/or an orientation of mobile device 102 (e.g., with respect to environment 100). By way of example, in certain implementations mobile device 102 may comprise a transmitter and an applicable antenna arrangement to transmit an electromagnetic signal as a controlled or otherwise directional beam. A receiver may, for example, be tuned to receive a corresponding signal which may or may not comprise the reflected version of the detection signal. In certain other example implementations, a detection signal may be transmitted in an omni-directional or other like broad pattern. In certain example implementations, a reflection may be used to help determine an orientation of mobile device 102, e.g., relative to one or more signaling apertures, and/or an absolute orientation where the orientation of the signaling apertures may be determined by other means such as a map or by observing which external signals are available and their relative strengths. Hence, in certain example implementations, a mobile device 102 may obtain and access applicable satellite ephemeris or an almanac of transmitting devices, and/or an electronic map relating to at least a portion of a structure, building, etc.

In certain example implementations, a received signal may be associated with a particular direction with respect to mobile device 102, and/or an orientation of mobile device 102 (e.g., with respect to environment 100). By way of example, in certain implementations mobile device 102 may comprise a receiver and an applicable antenna arrangement to receive an electromagnetic signal from a particular direction or region, e.g., associated with a beam reception. A receiver may, for example, be tuned to receive a corresponding signal which may or may not comprise the reflected version of a detection signal. Here, for example, the detection signal may have been transmitted as a directional beam or in an omni-directional or other like broad pattern. In certain other example implementations, a received signal may be received in an omni-directional or other like broad reception pattern.

In certain example implementations, mobile device 102 may comprise one or more transmitters, one or more receivers, and/or one or more antenna arrangements for specific use with signaling aperture detector 104. In certain other example implementations, mobile device 102 may comprise one or more transmitters, one or more receivers, and/or one or more antenna arrangements that are used for other functions, e.g., wireless network communications, etc. Thus, for example, a transmitter and/or a receiver of mobile device 102 associated with signaling aperture detector 104 may be part of a wireless network interface provided within mobile device 102. In certain example implementations, all or part of a transmitter and/or receiver may be provided in mobile device as part of one or more transceivers. In certain example implementations, an antenna arrangement may comprise one or more antennas or antenna elements. For example, in certain implementations, a transmitter and/or a receiver may use a diversity antenna arrangement, e.g., for beam forming, beam reception, etc.

In certain example implementations, signaling aperture detector 104 may associate a signaling aperture with a particular direction with respect to mobile device 102, environment 100, and/or an orientation of mobile device 102 with respect to environment 100. Thus, as illustrated in FIG. 1, one or more orientation axis 110 (illustrated in this example with Cartesian coordinates x, y and z) may be associated with mobile device 102 and/or environment 100. Mobile device 102 may, for example, determine its orientation with respect to environment 100 based, at least in part, on one or more additional signals associated with one or more inertial sensors (e.g., accelerometer(s), gyroscope(s), and/or the like or combination thereof), one or more environment sensors (e.g., a magnetometer, compass, a gravitometer, a light sensor, a pressure sensor, and/or the like or combination thereof), and/or one or more transmitting devices (e.g., a SPS transmitting device 114, a wireless network transmitting device 122, another mobile device, etc.). In an example implementation, a direction relating to a transmitted detection signal and/or a direction of a received signal which may comprise a reflected version of a detection signal may be associated with a determined orientation of mobile device 102. In still further example implementations, a determined orientation of mobile device 102 may be associated with one or more other reference coordinate systems that may associated with environment 100, SPS 112, wireless network 120, and/or the like. For example, in certain implementations, a determined orientation of mobile device 102 may be associated with an Earth-Centered, Earth-Fixed (ECEF) Cartesian coordinate system or the like. Accordingly, a signaling aperture may be associated with a particular ECEF region or other like definable region within environment 100. For example, an opening within a ceiling or wall of structure 108 that is determined to represent a signaling aperture may be associated with a particular region of environment 100 for receiving and/or transmitting certain electromagnetic signals either via a LOS path and/or NLOS path. In certain example instances, an orientation may be determined relative to a map of a structure, building, room, environment, etc., that mobile device 102 may be located in or nearby.

Signaling aperture detector 104 may, for example, affect an operation of one or more functions performed (in-whole or in-part) by mobile device 102 based, at least in part, on a determination as to whether a signaling aperture is determined to be present within environment 100. For example, signaling aperture detector 104 may affect an operation of navigation function 106 based, at least in part, on whether a signaling aperture is determined to be present within environment 100. For example, signaling aperture detector 104 may affect selection and/or initiation of (or conversely termination or halting of) an operation of navigation function 106 based, at least in part, on whether one or more signaling apertures are or are not determined to be present. Here, for example, signaling aperture detector 104 may affect a particular operation of navigation function 106 that may be more useful when certain signaling aperture(s) are present to permit signals from orbiting SPS satellites to be more likely received via a LOS path than by a NLOS path. Here, for example, signaling aperture detector 104 may affect a particular operation of navigation function 106 that may be more useful when certain other signaling aperture(s) are present or not present to permit signals from terrestrial transmitting devices (e.g., associated with SPS 112, wireless network 120, etc.) to be more likely received via a LOS path and/or possibly a NLOS path. In certain example implementations, with a determined direction to a signaling aperture and knowledge of a transmitting device, mobile station 102 may predict which signals should be strongest (passing through the signaling aperture) and search for such signals first.

In certain example implementations, signaling aperture detector 104 may associate at least a portion of environment 100 with an electronic map based, at least in part, on a presence or absence of one or more signaling apertures. For example, an electronic map may be indicative of structure 108 or a portion thereof that is expected to present a particular pattern of present or absent signaling apertures to a mobile device therein at certain position locations. Thus, signaling aperture detector 104 may, in certain example implementations, associate mobile device 102 as being at or near to some position location within environment 100 that may be indicated via an electronic map. By way of example, an electronic map may indicate certain geographical features and/or coordinates possibly relating to routes, natural or man-made structures, available services, business locations, addresses, various images, distance information, floor plans, other like information and/or metadata, etc.

In certain example implementations, signaling aperture detector 104 may affect an operation of navigation function 106 based, at least in part, on a region of environment 100 associated with a signaling aperture with respect to an orientation of mobile device 102. For example, signaling aperture detector 104 may affect a signal acquisition operation of navigation function 106 based, at least in part, on a region of environment 100 associated with a signaling aperture with respect to an orientation of mobile device 102 within environment 100. For example, a signal acquisition operation of navigation function 106 may be affected by signaling aperture detector 104 to focus a search process for SPS signals to those SPS transmitting devices that are predicted to be within a region of environment 100 associated with a signaling aperture (e.g., based on ephemeris data, a current time, a last known or estimated position location of mobile device 102, etc.).

In certain example implementations, signaling aperture detector 104 may affect one or more weighting parameters and/or other like inputs to affect one or more operations of navigation function 106 in some manner. For example, more weight, consideration, and/or processing resources may be applied to an open-sky SPS search algorithm when one or more signaling apertures are determined to be present overhead. It should be understood that navigation function 106 may comprise a plurality of operations, two or more of which may be concurrently performed.

Since certain electromagnetic signals may be affected differently by materials and/or objects within environment 100, a detection signal may, for example, comprise an electromagnetic signal that may be the same or similar to one or more particular signals to be received and/or transmitted by mobile device 102. For example, a detection signal may comprise an RF signal having a frequency that is within a threshold range of a center frequency associated with a particular SPS signal, and/or a particular wireless network signal. A detection signal may, for example, comprise a short pulse wave, an impulse, a series of pulses, etc.

In other certain example implementations, however, a detection signal may comprise an electromagnetic signal that may not represent an RF signal. For example, in certain implementations a detection signal and/or corresponding received signal may comprise an infrared signal, a visible light signal, and/or an ultraviolet signal.

Mobile device 102 is representative of any electronic device that may be moved about within environment 100. For example, mobile device 102 may comprise a hand-held computing and/or communication device, such as, a mobile telephone, smart phone, lap top computer, navigation device, and/or the like. For example, mobile device 102 may be part of a circuit board, an electronic chip, a machine, a vehicle, a container, etc.

In certain example implementations, mobile device 102 may function exclusively and/or selectively as a stand-alone device, and/or may provide a one or more capabilities/services in conjunction with one or more other devices. In certain example implementations, mobile device 102 may communicate in some manner with one or more other devices resources (devices) 126, for example as illustrated in FIG. 1 via wireless communication signal 121, wireless network 120, and communication link 124. Wireless network 120 and/or communication link 124 may be representative of one or more communication and/or computing resources (e.g., devices and/or services) which mobile device 102 may communicate with or through using one or more wired or wireless communication links. Thus, in certain instances mobile device 102 may receive data and/or instructions via wireless network 120.

In certain example implementations, communication link 124 and/or other resources (devices) 126 may comprise a wired or wireless local area network, an intranet, the Internet, etc. In certain example implementations, other resources (devices) 126 may comprise one or more computing devices, a cloud computing arrangement, one or more servers, etc., from/to which one or more electronic signals representative of information and/or computer-implementable instructions may be received/sent.

In certain example implementations, SPS 112 may be representative of one or more Global Navigation Satellite Systems (GNSSs), or other like satellite and/or terrestrial locating services, such as, e.g., one or more location based services (LBSs) which may be provided, at least in part, by a cellular network, a WiFi network, etc.

Mobile device 102 may, for example, be enabled (e.g., via one or more network interfaces) for use with various wireless communication networks such as a wireless wide area network (WWAN), a wireless local area network (WLAN), a wireless personal area network (WPAN), and so on. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rd Generation Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, for example. Wireless communication networks may include so-called next generation technologies (e.g., “4G”), such as, for example, Long Term Evolution (LTE), Advanced LTE, WiMAX, Ultra Mobile Broadband (UMB), and/or the like.

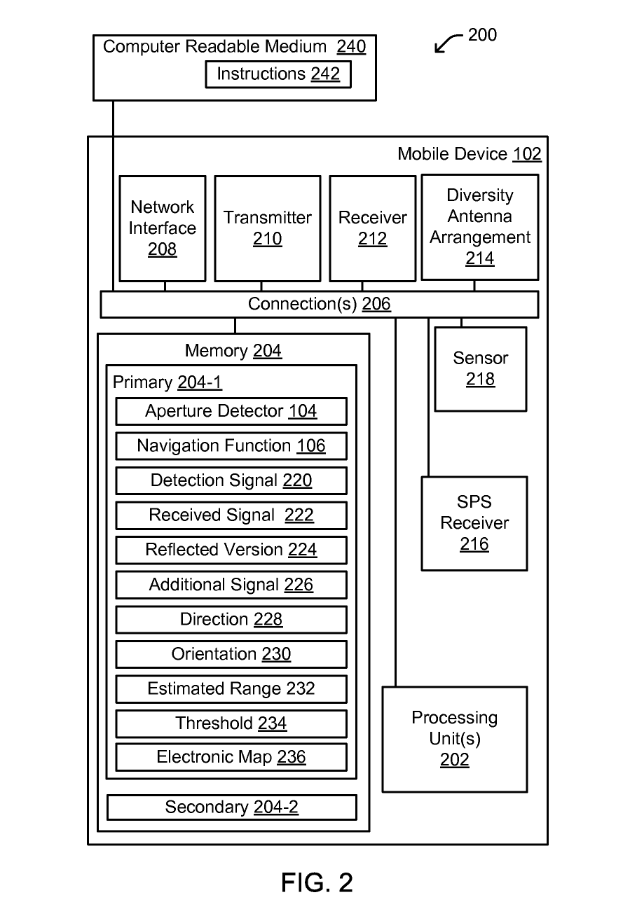

Reference is made next to FIG. 2, which is a schematic block diagram illustrating certain features of mobile device 102, for example as in FIG. 1, in accordance with an implementation.

As illustrated mobile device 102 may comprise one or more processing units 202 to perform data processing (e.g., in accordance with the techniques provided herein) coupled to memory 204 via one or more connections 206. Processing unit(s) 202 may, for example, be implemented in hardware or a combination of hardware and software. Processing unit(s) 202 may, for example, be representative of one or more circuits configurable to perform at least a portion of a data computing procedure or process. By way of example but not limitation, a processing unit may include one or more processors, controllers, microprocessors, microcontrollers, application specific integrated circuits, digital signal processors, programmable logic devices, field programmable gate arrays, and the like, or any combination thereof.

Memory 204 may be representative of any data storage mechanism. Memory 204 may include, for example, a primary memory 204-1 and/or a secondary memory 204-2. Primary memory 204-1 may comprise, for example, a random access memory, read only memory, non-volatile memory/FLASH, etc. While illustrated in this example as being separate from the processing units, it should be understood that all or part of a primary memory may be provided within or otherwise co-located/coupled with processing unit(s) 202, or other like circuitry within mobile device 102. Secondary memory 204-2 may comprise, for example, the same or similar type of memory as primary memory and/or one or more data storage devices or systems, such as, for example, a disk drive, an optical disc drive, a tape drive, a solid state memory drive, etc. In certain implementations, secondary memory may be operatively receptive of, or otherwise configurable to couple to, a non-transitory computer readable medium 240. Memory 204 and/or non-transitory computer readable medium 240 may comprise computer-implementable instructions 242 associated with certain example techniques as provided herein.

As illustrated in FIG. 2, at various times memory 204 may store certain signals representing data and/or computer-implementable instructions associated with certain example techniques as provided herein. For example, memory 204 may store data and/or computer-implementable instructions associated with signaling aperture detector 104 and/or navigation function 106. By way of example, memory 204 may at various times store data associated with a detection signal 220, a received signal 222, a reflected version 224, an additional signal 226, a direction 228, an orientation 230, an estimated range 232, a threshold 234, and/or an electronic map 236.

As shown, mobile device 102 may also comprise, for example, one or more of: a network interface 208, a transmitter 210, a receiver 212, a diversity antenna arrangement 214, a sensor 218, and a SPS receiver 216. It should be understood that mobile device 102 may also or alternatively comprise one or more other circuits, mechanisms, etc., (not shown) that may be of use in performing one or more other functions or capabilities, and/or supportive of certain example techniques as provided herein. For example, mobile device 102 may comprise one or more input/output devices (e.g., a display, a touch pad, a key pad, a button, a port, a digital camera, a speaker, a microphone, etc.), a power supply (e.g., a battery), one or more other antennas (e.g., one or more RF antennas or antenna elements, and/or one or more non-RF antennas or antenna elements), one or more non-RF electromagnetic signal transmitters, one or more non-RF electromagnetic signal receivers, and/or the like.

Network interface 208 may, for example, provide a capability to receive and/or transmit wireless network signal 121 (see FIG. 1). Thus, network interface 208 may, for example, comprise a receiver and a transmitter, and/or other like transceiver. In certain example implementations, a transmitter of network interface 208 may be employed by signaling aperture detector 104 to transmit a detection signal. In certain example implementations, a receiver of network interface 208 may be employed by signaling aperture detector 104 to receive a signal within environment 100 (see FIG. 1) which may comprise a reflected version of a transmitted detection signal.

Transmitter 210 may, for example, be employed by signaling aperture detector 104 to transmit an electromagnetic signal representing detection signal 220. Thus, transmitter 210 may be representative of an RF signal transmitter and/or a non-RF signal transmitter. In certain example implementations, transmitter 210 may support other functions performed by mobile device 102.

Receiver 212 may, for example, be employed by signaling aperture detector 104 to receive an electromagnetic signal representing received signal 222 which may comprise a reflected version 224 of a transmitted detection signal. Thus, receiver 212 may be representative of an RF signal receiver and/or a non-RF signal receiver. In certain example implementations, receiver 212 may support other functions performed by mobile device 102.

Diversity antenna arrangement 214 may, for example, comprise a plurality of antennas and/or antenna elements. Diversity antenna arrangement 214 may, for example, be employed by network interface 208 or transmitter 210 to transmit an electromagnetic signal representing detection signal 220 in one or more particular directions and/or patterns, e.g., using beam forming, and/or or other like techniques. Diversity antenna arrangement 214 may, for example, be employed by network interface 208 or receiver 212 to receive an electromagnetic signal representing received signal 222 which may comprise a reflected version 224 of a transmitted detection signal 220, e.g., using beam reception and/or or other like techniques.

It should be understood, however, that in other example implementations, one or more other antenna arrangements (not shown) may be provided for use by network interface 208, transmitter 210, and/or receiver 212. For example, one or more RF antennas or antenna elements, and/or one or more non-RF antennas or the like may be provided for use in transmitting (e.g., emitting) detection signal 220, and/or receiving (e.g., detecting) received signal 222. In certain example implementations, one or more other antenna arrangements (not shown) may support other functions performed by mobile device 102.

Sensor 218 may be representative of one or more inertial sensors which may be responsive to movement of mobile device 102 and/or other forces which may act upon mobile device 102 in some manner. By way of example, sensor 218 may comprise one or more accelerometers, gyroscopes, and/or the like, which may generate additional signal(s) 226 that may be used to determine or otherwise estimate a movement and/or orientation of mobile device 102.

Sensor 218 may be representative of one or more environment sensors which may be responsive to measurable characteristics of environment 100. By way of example, sensor 218 may comprise a magnetometer, a compass, a gravitometer, a light sensor, an atmospheric pressure sensor, and/or the like, which may generate additional signal(s) 226 that may be used to determine or otherwise estimate a movement and/or orientation of mobile device 102 with regard to environment 100. Signaling aperture detector 104 may, for example, compare additional signal(s) 226 to one or more thresholds. A threshold 234 may, for example, comprise a signal representative of one or more applicable values that may be predetermined and/or dynamically determined.

SPS receiver 216 may, for example, be representative of one or more circuits and/or processing units available to provide and/or otherwise support signal-based position location estimation of mobile device 102 with regard to one more transmitting devices. For example, SPS receiver 216 may provide or otherwise support navigation function 106. By way of example, SPS receiver 216 may provide additional signal 226 relating to SPS signals received from SPS transmitting devices (e.g., satellites, terrestrial, etc.).

In certain example implementations, network interface 208 may, for example, be representative of one or more circuits and/or processing units available to provide and/or otherwise support signal-based position location estimation of mobile device 102 with regard to one more wireless network transmitters and/or other like terrestrial transmitting devices. For example, network interface 208 may provide or otherwise support navigation function 106. By way of example, network interface 208 may provide additional signal 226 relating to wireless network and/or other like signals received from one more wireless network transmitting devices and/or other like terrestrial transmitting devices.

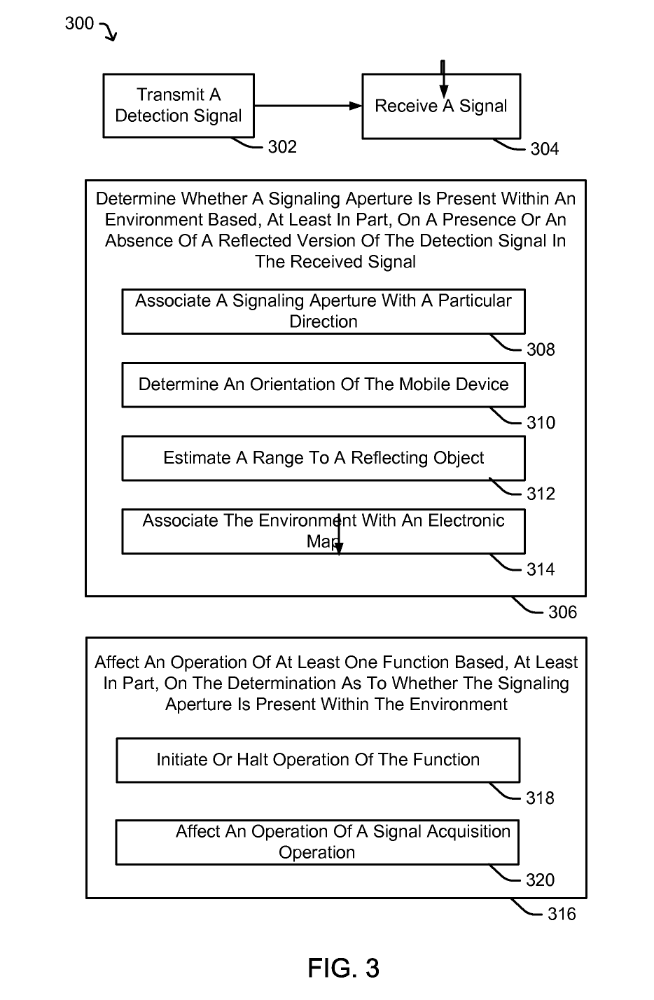

Attention is drawn next to FIG. 3, which is a flow diagram illustrating an example method 300 for use in mobile device 102, in accordance with an implementation.

At block 302, for example, at least one detection signal may be transmitted by a mobile device. For example, a detection signal may comprise one or more electromagnetic signals that are transmitted in a particular direction and/or pattern within an environment surrounding a mobile device. A detection signal may have particularly selected signaling characteristics (e.g., particular waveform, particular frequency or frequency band, transmission power level, beam pattern or shape, etc.). In certain instances, at least a part of a detection signal may be reflected by one or more reflecting objects within the environment.

At block 304, for example, at least one signal may be received by a mobile device within an environment, and such received signal may or may not comprise a reflected version of a previously transmitted detection signal. For example, a received signal may comprise an electromagnetic signal that is received from a particular direction and/or in a particular pattern within an environment surrounding a mobile device. In certain instances, at least a part of a received signal may comprise a reflected version of a previously transmitted detection signal due to one or more reflecting objects within the environment.

At block 306, a determination may be made as to whether a signaling aperture may or may not be present within an environment based, at least in part, on a presence or an absence of a reflected version of a detection signal in a received signal. For example, it may be determined that a signaling aperture may not be present based, at least in part, on a presence of a reflected version of a detection signal in a received signal. For example, it may be determined that a signaling aperture may not be present based, at least in part, on a presence of a reflected version of a detection signal in a received signal within a threshold amount of time (e.g., associated with a time of signal propagation, a range from a mobile device to a reflecting object, etc.). Conversely, for example, it may be determined that a signaling aperture may be present based, at least in part, on an absence of a reflected version of a detection signal in a received signal. For example, it may be determined that a signaling aperture may be present based, at least in part, on an absence of a reflected version of a detection signal in a received signal within a threshold amount of time (again, e.g., associated with a time of signal propagation, a range from a mobile device to a reflecting object, etc.). In certain example implementations, a mobile device may determine whether a signaling aperture is present within an environment based, at least in part, on at least one characteristic of a reflected version of a detection signal in a received signal. For example, characteristics such as a waveform, a phase, frequency or frequency band, received power level, diversity reception differences, and/or the like may be considered.

In certain example implementations, at block 308, a signaling aperture may be associated with a particular direction. For example, a signaling aperture may be associated with a particular direction with respect to mobile device 102.

In certain example implementations, at block 310, an orientation of a mobile device may be determined or otherwise estimated. For example, one or more sensors (e.g., inertial sensors and/or environment sensors) within a mobile device may be used to determine or otherwise estimate such orientation.

In certain example implementations, at block 312, a range from a mobile device to a reflecting object may be estimated, e.g., based on a round-trip time of propagation of a transmitted detection signal to receipt of a reflected version of the transmitted detection signal. For example, techniques employed in radar devices, ranging devices, and/or other like remote and/or proximity sensing devices may be employed.

In certain example implementations, at block 314, at least a portion of a sensed environment may be associated with at least a portion of an electronic map. For example, one or more signaling apertures and/or or lack thereof may be used, possibly along with other position location information and/or additional signals to estimate a position location of a mobile device within the environment or portion thereof.

At block 316, for example, an operation of at least one function may be affected based, at least in part, on a determination as to whether a signaling aperture is present within the environment. In certain instances, for example, an operation of a navigation function or the like may be affected at block 316. In certain instances, for example, an operation of a communication function or the like may be affected at block 316. In certain instances, for example, an operation of a data processing function or the like may be affected at block 316. For example, at block 318, an operation of at least one function may be initiated or halted based, at least in part, on a determination as to whether a signaling aperture is present within the environment. For example, at block 320, an operation of a signal acquisition operation may be affected in some manner based, at least in part, on a determination as to whether a signaling aperture is present within the environment. In certain instances, for example, one or more functions may be involved in an interactive session between the mobile device and one or more other devices (e.g., mobile devices, etc.). For example, in certain example implementations, an interactive session may relate to a various communications and/or user inputs associated with a game. In certain example implementations, an orientation of a mobile device may be determined using the techniques provided herein which may be taken into consideration in receiving user inputs. For example, a determined orientation may be used to identify a particular user input along with signals generated by one or more inertial sensors. In certain example implementations, an operation of a compass function or the like may be affected at block 316. For example, a compass function may be calibrated or otherwise supplemented using the aperture sensor in environments wherein the compass function may otherwise be impaired (e.g., within certain indoor structures, nearby certain magnetic fields or metallic objects, etc.).

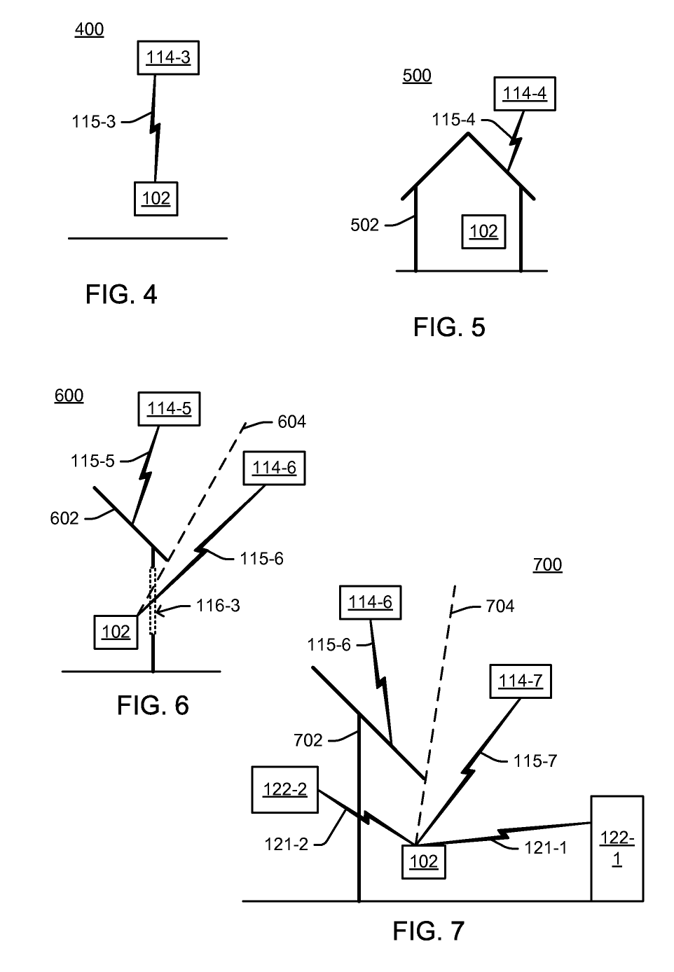

By way of further example, as illustrated in environment 400 of FIG. 4, in certain example implementations, in response to a determination that a signaling aperture is determined to be present within the environment, an open-sky SPS signal search algorithm may be initiated in an attempt to receive SPS signals via LOS reception. For example, mobile device 102 may receive SPS signal 115-3 from SPS transmitting device 114-3 via LOS reception.

As illustrated in environment 500 in FIG. 5, in certain example implementations, in response to a determination that a signaling aperture is not determined to be present within the environment, a closed-sky SPS signal search algorithm may be initiated in an attempt to receive SPS and/or other positioning signals via NLOS reception. Here, for example, a structure 502 may not present any determined signaling apertures to allow mobile device 102 to receive SPS signal 115-4 from SPS transmitting device 114-4 via LOS reception.

As illustrated in environment 600 in FIG. 6, in certain example implementations, in response to a determination that at least one signaling aperture 116-3 is determined to be present within the environment, a directional based open-sky SPS signal search algorithm may be initiated in an attempt to receive certain SPS signals via LOS reception, and/or a directional based closed-sky SPS signal search algorithm may be initiated in an attempt to receive SPS and/or other positioning signals via NLOS reception. Here, for example, dashed line 604 illustrates a boundary between a closed-sky to SPS transmitting device 114-5 due to structure 602, and a more open-sky to SPS transmitting device 114-6. Hence, it may be possible to directionally search for and receive SPS signal 115-6 through signaling aperture 116-3. It may also be possible, should it be desired to attempt to receive SPS signal 115-5 via possible NLOS reception. In certain example implementations, mobile device 102 may determine a predicted reception time for NLOS signals and search for applicable weaker signals at the appropriate time proactively without having determined which signals may be received LOS first, e.g., based on estimated directions signaling apertures. In certain example implementations, mobile device 102 may actively sweep or otherwise act to beam one or more signals across a wall to determine based on the strength and timing of the reflected signal where the edges of a signaling aperture are, e.g., to estimate how far away a signaling aperture or one or more of its boundaries may be, a size or shape, a type, and/or direction(s) thereto. In certain example implementations, a mobile device may obtain one or more electronic maps for use with changes in a characteristic and/or a direction of a detection signal and orientation of the mobile device to determine a direction and a size, a shape, and/or a distance of a signaling aperture.

As illustrated in environment 700 in FIG. 7, in certain example implementations, in response to a determination that at least one signaling aperture is determined to be present within the environment, a directional based open-sky SPS signal search algorithm may be initiated in an attempt to receive certain SPS signals via LOS reception, and/or a directional based closed-sky SPS signal search algorithm may be initiated in an attempt to receive SPS and/or other positioning signals via NLOS reception, and/or other signals may be searched for and received (e.g., a wireless network signal). Here, for example, dashed line 704 illustrates a boundary between a closed-sky to SPS transmitting device 114-6 due to structure 702, and a more open-sky to SPS transmitting device 114-7. Hence, it may be possible to directionally search for and receive SPS signal 115-7. It may also be possible, should it be desired to attempt to receive SPS signal 115-6 via possible NLOS reception, and/or other signals may be searched for and/or received. For example, mobile device 102 may receive a wireless network signal 121-1 from transmitting device 122-1 located outside of structure 702, and/or a wireless network signal 121-2 from a transmitting device 122-2 located inside structure 702. With regard to wireless network signal 121-2 from transmitting device 122-2 located inside structure 702, an applicable signaling aperture may or may not have been detected by mobile device 102 however in certain instances wireless network signal 121-2 may be transmitted at a power level and/or over a frequency band that may be less affected by structure 702 than might certain SPS signals.

Reference throughout this specification to “one example”, “an example”, “certain examples”, or “example implementation” means that a particular feature, structure, or characteristic described in connection with the feature and/or example may be included in at least one feature and/or example of claimed subject matter. Thus, the appearances of the phrase “in one example”, “an example”, “in certain examples” or “in certain implementations” or other like phrases in various places throughout this specification are not necessarily all referring to the same feature, example, and/or limitation. Furthermore, the particular features, structures, or characteristics may be combined in one or more examples and/or features.

The methodologies described herein may be implemented by various means depending upon applications according to particular features and/or examples. For example, such methodologies may be implemented in hardware, firmware, and/or combinations thereof, along with software. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter.

Some portions of the preceding detailed description have been presented in terms of algorithms or symbolic representations of operations on binary digital electronic signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, is considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated as electronic signals representing information. It has proven convenient at times, principally for reasons of common usage, to refer to such signals as bits, data, values, elements, symbols, characters, terms, numbers, numerals, information, or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining”, “establishing”, “obtaining”, “identifying”, and/or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device. In the context of this particular patent application, the term “specific apparatus” may include a general purpose computer once it is programmed to perform particular functions pursuant to instructions from program software.

The terms, “and”, “or”, and “and/or” as used herein may include a variety of meanings that also are expected to depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe a plurality or some other combination of features, structures or characteristics. Though, it should be noted that this is merely an illustrative example and claimed subject matter is not limited to this example.

While there has been illustrated and described what are presently considered to be example features, it will be understood by those skilled in the art that various other modifications may be made, and equivalents may be substituted, without departing from claimed subject matter. Additionally, many modifications may be made to adapt a particular situation to the teachings of claimed subject matter without departing from the central concept described herein.

Therefore, it is intended that claimed subject matter not be limited to the particular examples disclosed, but that such claimed subject matter may also include all aspects falling within the scope of appended claims, and equivalents thereof.

What is claimed is:

1. A method comprising, at a mobile device:
determining whether a signaling aperture is present within an environment based, at least in part, on a presence or an absence of a reflected version of a detection signal in a received signal; and
affecting an operation of at least one function based, at least in part, on said determination as to whether said signaling aperture is present within said environment.

2. The method as recited in claim 1, wherein said at least one function comprises a navigation function.

3. The method as recited in claim 1, wherein said at least one function is used by said mobile device as part of an interactive session with at least one other device.

4. The method as recited in claim 1, further comprising, at said mobile device:
determining whether said signaling aperture is present within said environment based, at least in part, on at least one characteristic of said reflected version of said detection signal in said received signal.

5. The method as recited in claim 4, further comprising, at said mobile device:
characterizing said signaling aperture based, at least in part, on at least one characteristic of said reflected version of said detection signal in said received signal.

6. The method as recited in claim 4, further comprising, at said mobile device:
affecting said detection signal to characterize said signaling aperture.

7. The method as recited in claim 1, further comprising, at said mobile device:
associating said signaling aperture with a particular direction with respect to at least one of: said mobile device, said environment, or an orientation of said mobile device with respect to said environment.

8. The method as recited in claim 1, further comprising, at said mobile device:
determining an orientation of said mobile device with respect to said environment based, at least in part, on an additional signal associated with at least one of: an inertial sensor, an environment sensor, or a transmitting device.

9. The method as recited in claim 8, further comprising, at said mobile device:
affecting a compass function based, at least in part, on said orientation.

10. The method as recited in claim 8, wherein affecting said operation of said at least one function further comprises:
affecting said operation of said at least one function based, at least in part, on said signaling aperture with respect to said orientation of said mobile device.

11. The method as recited in claim 1, further comprising, at said mobile device:
transmitting said detection signal using a transmitter; and
receiving said received signal using a receiver.

12. The method as recited in claim 11, wherein said detection signal comprises a plurality of different signals comprising different signal characteristics.

13. The method as recited in claim 11, wherein at least one of said transmitter or said receiver is part of a wireless network interface.

14. The method as recited in claim 11, wherein at least one of said transmitter or said receiver uses a diversity antenna arrangement.

15. The method as recited in claim 11, wherein said detection signal is transmitted in a particular direction with respect to at least one of: said mobile device, or an orientation of said mobile device with respect to said environment.

16. The method as recited in claim 11, wherein said received signal is associated with a particular direction with respect to at least one of: said mobile device, or an orientation of said mobile device with respect to said environment.

17. The method as recited in claim 1, wherein said at least one function is responsive, at least in part, to at least one of: a received SPS signal, or a wireless network signal.

18. The method as recited in claim 17, wherein said detection signal comprises an electromagnetic signal having a frequency that is within a threshold range of a center frequency associated with at least one of: said received SPS signal, or said wireless network signal.

19. The method as recited in claim 1, wherein said detection signal does not comprise a radio frequency signal.

20. The method as recited in claim 1, wherein affecting said operation of said at least one function further comprises at least one of: initiating said operation, or halting said operation.

21. The method as recited in claim 1, wherein affecting said operation of said at least one function further comprises:
affecting a signal acquisition operation.

22. The method as recited in claim 1, further comprising, at said mobile device:
estimating a range a reflecting object within said environment based, at least in part, on said reflected version of said detection signal.

23. The method as recited in claim 1, further comprising, at said mobile device:
associating said environment with an electronic map based, at least in part, on said signaling aperture.

24. An apparatus for use in a mobile device, the apparatus comprising:
means for transmitting a detection signal;
means for receiving a received signal;
means for determining whether a signaling aperture is present within an environment based, at least in part, on a presence or an absence of a reflected version of said detection signal in said received signal; and
means for affecting an operation of at least one function based, at least in part, on said determination as to whether said signaling aperture is present within said environment.

25. The apparatus as recited in claim 24, wherein said at least one function comprises a navigation function.

26. The apparatus as recited in claim 24, wherein said at least one function is used by said mobile device as part of an interactive session with at least one other device.

27. The apparatus as recited in claim 24, further comprising:
means for determining whether said signaling aperture is present within said environment based, at least in part, on at least one characteristic of said reflected version of said detection signal in said received signal.

28. The apparatus as recited in claim 27, further comprising:
means for characterizing said signaling aperture based, at least in part, on at least one characteristic of said reflected version of said detection signal in said received signal.

29. The apparatus as recited in claim 27, further comprising:
means for affecting said detection signal to characterize said signaling aperture.

30. The apparatus as recited in claim 24, further comprising:
means for associating said signaling aperture with a particular direction with respect to at least one of: said mobile device, said environment, or an orientation of said mobile device with respect to said environment.

31. The apparatus as recited in claim 24, further comprising:
means for determining an orientation of said mobile device with respect to said environment based, at least in part, on an additional signal associated with at least one of: an inertial sensor, an environment sensor, or a transmitting device.

32. The apparatus as recited in claim 31, further comprising:
means for affecting a compass function based, at least in part, on said orientation.

33. The apparatus as recited in claim 24, wherein said detection signal is transmitted in a particular direction with respect to at least one of: said mobile device, or an orientation of said mobile device with respect to said environment.

34. The apparatus as recited in claim 24, wherein said received signal is associated with a particular direction with respect to at least one of: said mobile device, or an orientation of said mobile device with respect to said environment.

35. The apparatus as recited in claim 24, wherein said detection signal comprises a plurality of different signals comprising different signal characteristics.

36. The apparatus as recited in claim 24, wherein said at least one function is responsive, at least in part, to at least one of: a received SPS signal, or a wireless network signal.

37. The apparatus as recited in claim 36, wherein said detection signal comprises an electromagnetic signal having a frequency that is within a threshold range of a center frequency associated with at least one of: said received SPS signal, or said wireless network signal.

38. The apparatus as recited in claim 24, further comprising:
means for estimating a range a reflecting object within said environment based, at least in part, on said reflected version of said detection signal.

39. The apparatus as recited in claim 24, further comprising:
means for associating said environment with an electronic map based, at least in part, on said signaling aperture.

40. A mobile device comprising:
a transmitter;
a receiver;
a processing unit to:
initiate transmission of a detection signal within an environment via said transmitter;
obtain a signal received via said receiver;
determine whether a signaling aperture is present within said environment based, at least in part, on a presence or an absence of a reflected version of said detection signal in said received signal; and
affect an operation of at least one function based, at least in part, on said determination as to whether said signaling aperture is present within said environment.

41. The apparatus as recited in claim 40, wherein said at least one function comprises a navigation function.

42. The apparatus as recited in claim 40, wherein said at least one function is used by said mobile device as part of an interactive session with at least one other device.

43. The mobile device as recited in claim 40, said processing unit to:
determine whether said signaling aperture is present within said environment based, at least in part, on at least one characteristic of said reflected version of said detection signal in said received signal.

44. The mobile device as recited in claim 43, said processing unit to:
characterize said signaling aperture based, at least in part, on at least one characteristic of said reflected version of said detection signal in said received signal.

45. The mobile device as recited in claim 43, said processing unit to:
affect said detection signal to characterize said signaling aperture.

46. The mobile device as recited in claim 40, said processing unit to:
associate said signaling aperture with a particular direction with respect to at least one of: said mobile device, said environment, or an orientation of said mobile device with respect to said environment.

47. The mobile device as recited in claim 40, further comprising:
at least one of: an inertial sensor, an environment sensor, and said processing unit to:
determine an orientation of said mobile device with respect to said environment based, at least in part, on an additional signal associated with at least one of: said inertial sensor, said environment sensor, or a transmitting device.

48. The mobile device as recited in claim 47, said processing unit to:
affect a compass function based, at least in part, on said orientation.

49. The mobile device as recited in claim 47, said processing unit to:
affect said operation of said at least one function based, at least in part, on said signaling aperture with respect to said orientation of said mobile device.

50. The mobile device as recited in claim 40, wherein at least one of said transmitter or said receiver is part of a wireless network interface.

51. The mobile device as recited in claim 40, further comprising:
a diversity antenna arrangement; and
wherein at least one of: said transmitter uses said diversity antenna arrangement to transmit said detection signal, or said receiver uses said diversity antenna arrangement to receive said received signal.

52. The mobile device as recited in claim 40, wherein said detection signal is transmitted in a particular direction with respect to at least one of: said mobile device, or an orientation of said mobile device with respect to said environment.

53. The mobile device as recited in claim 40, wherein said received signal is associated with a particular direction with respect to at least one of: said mobile device, or an orientation of said mobile device with respect to said environment.

54. The mobile device as recited in claim 40, wherein said detection signal comprises a plurality of different signals comprising different signal characteristics.

55. The mobile device as recited in claim 40, wherein said at least one function is responsive, at least in part, to at least one of: a received SPS signal, or a wireless network signal.

56. The mobile device as recited in claim 55, wherein said detection signal comprises an electromagnetic signal having a frequency that is within a threshold range of a center frequency associated with at least one of: said received SPS signal, or said wireless network signal.

57. The mobile device as recited in claim 40, wherein said detection signal does not comprise a radio frequency signal.

58. The mobile device as recited in claim 40, said processing unit to affect said operation of said at least one function by initiating said operation, or halting said operation.

59. The mobile device as recited in claim 40, said processing unit to:
estimate a range a reflecting object within said environment based, at least in part, on said reflected version of said detection signal.

60. The mobile device as recited in claim 40, further comprising:
memory; and
said processing unit to: associate said environment with an electronic map obtained from said memory based, at least in part, on said signaling aperture.

61. An article comprising:
a non-transitory computer readable medium having stored therein computer-implementable instructions executable by one or more processing units of a mobile device to:
initiate transmission of a detection signal within an environment;
obtain a signal received within said environment;
determine whether a signaling aperture is present within said environment based, at least in part, on a presence or an absence of a reflected version of said detection signal in said received signal; and
affect an operation of a at least one function based, at least in part, on said determination as to whether said signaling aperture is present within said environment.

62. The article as recited in claim 61, wherein said at least one function comprises a navigation function.

63. The article as recited in claim 61, wherein said at least one function is used by said mobile device as part of an interactive session with at least one other device.

64. The article as recited in claim 61, wherein said computer-implementable instructions are further executable by said one or more processing units to:
determine whether said signaling aperture is present within said environment based, at least in part, on at least one characteristic of said reflected version of said detection signal in said received signal.

65. The article as recited in claim 64, wherein said computer-implementable instructions are further executable by said one or more processing units to:
characterize said signaling aperture based, at least in part, on at least one characteristic of said reflected version of said detection signal in said received signal.

66. The article as recited in claim 64, wherein said computer-implementable instructions are further executable by said one or more processing units to:
affect said detection signal to characterize said signaling aperture.

67. The article as recited in claim 61, wherein said computer-implementable instructions are further executable by said one or more processing units to:
associate said signaling aperture with a particular direction with respect to at least one of: said mobile device, said environment, or an orientation of said mobile device with respect to said environment.

68. The article as recited in claim 61, wherein said computer-implementable instructions are further executable by said one or more processing units to:
determine an orientation of said mobile device with respect to said environment based, at least in part, on an additional signal associated with at least one of: an inertial sensor, an environment sensor, or a transmitting device.

69. The article as recited in claim 68, wherein said computer-implementable instructions are further executable by said one or more processing units to:
affect a compass function based, at least in part, on said orientation.

70. The article as recited in claim 68, wherein said computer-implementable instructions are further executable by said one or more processing units to:
affect said operation of said at least one function based, at least in part, on said signaling aperture with respect to said orientation of said mobile device.

71. The article as recited in claim 61, wherein said detection signal is transmitted in a particular direction with respect to at least one of: said mobile device, or an orientation of said mobile device with respect to said environment.

72. The article as recited in claim 61, wherein said received signal is associated with a particular direction with respect to at least one of: said mobile device, or an orientation of said mobile device with respect to said environment.

73. The article as recited in claim 61, wherein said detection signal comprises a plurality of different signals comprising different signal characteristics.

74. The article as recited in claim 61, wherein said at least one function is responsive, at least in part, to at least one of: a received SPS signal, or a wireless network signal.

75. The article as recited in claim 74, wherein said detection signal comprises an electromagnetic signal having a frequency that is within a threshold range of a center frequency associated with at least one of: said received SPS signal, or said wireless network signal.

76. The article as recited in claim 61, wherein said detection signal does not comprise a radio frequency signal.

77. The article as recited in claim 61, wherein said computer-implementable instructions are further executable by said one or more processing units to: affect said operation of said at least one function by initiating said operation, or halting said operation.

78. The article as recited in claim 61, wherein said computer-implementable instructions are further executable by said one or more processing units to:
estimate a range a reflecting object within said environment based, at least in part, on said reflected version of said detection signal.

79. The article as recited in claim 61, wherein said computer-implementable instructions are further executable by said one or more processing units to:
associate said environment with an electronic map based, at least in part, on said signaling aperture.
